(19) United States
(12) Patent Application Publication
(10) Pub. No.: US 2014/0136496 A1
(43) Pub. Date: May 15, 2014

(54) SYSTEM, METHOD AND NON-TRANSITORY COMPUTER READABLE STORAGE MEDIUM FOR SUPPORTING NETWORK FILE ACCESSING AND VERSIONING WITH MULTIPLE PROTOCOLS IN A CLOUD STORAGE SERVER

(71) Applicant: INSTITUTE FOR INFORMATION INDUSTRY, Taipei (TW)

(72) Inventor: Yen-Hung KUO, Taipei City (TW)

(73) Assignee: INSTITUTE FOR INFORMATION INDUSTRY, TAIPEI (TW)

(21) Appl. No.: 13/712,978

(22) Filed: Dec. 13, 2012

(30) Foreign Application Priority Data
Nov. 14, 2012 (TW) 101142397

(51) Int. Cl. G06F 17/30

(52) U.S. Cl. CPC G06F 17/30194
USPC 707/695

(57) ABSTRACT

A method for accessing a file in a cloud storage server is provided. The method comprises the steps outlined below. A file update request is received from a remote device. A specific file is retrieved from a present version data storage area. A unique identification file name is calculated. The specific file is duplicated to generate a new file such that one of the specific file and the new file becomes a first file to be updated in the present version data storage and the other one of them becomes a second file to be moved to an old version data storage area. The second file is named by using the unique identification file name. The first file is updated in the present version data storage area according to the file update request. A database record is added to describe a versioning relationship between the first and the second files.

### RELATED APPLICATIONS

This application claims priority to Taiwan Application Serial Number 101142397, filed Nov. 14, 2012, which is herein incorporated by reference.

### BACKGROUND

1. Technical Field

The present invention relates to a network file access technology. More particularly, the present invention relates to a system, a method and a non-transitory computer readable storage medium for supporting network file accessing and versioning with multiple protocols in a cloud storage server.

2. Description of Related Art

The ubiquity of computers and other digital devices like mobile smart phones and tablets are enabling digital data storage technologies to gradually replace conventional information preservation methods that traditionally use writing or printing, paper and physical storage. The advantage of digital data storage includes its convenient accessibility, large capacity and ability for long-term preservation of information. Also the rapid development of computer networks including the internet that can connect devices at almost anytime and anywhere make it easier to retrieve (download) and store (upload) information objects with high speed and reliability. Hence, the combination of digital data storage and globally accessible network communication have given rise to “cloud storage server” wherein users can store information artifacts (e.g. files) including such objects as e-mails, personal documents, photographs, audio and video recordings in “cloud storage server” that are provided by computers on the network and allow that information to be easily and quickly retrieved, operated, or manipulated by different file access protocols through corresponding file access protocol interfaces.

A cloud storage server provides file access protocol interfaces can be accessed by devices with client applications which have capabilities of communicating with different file access protocols. For the devices such as desktops, laptops smart phones, tablets with an Internet browser application, a Common Internet File System (CIFS) client application, or a file synchronization application can be used to access files stored in the cloud storage server through the web file access interface, the CIFS interlace, and the file synchronization interface respectively. Different file access interfaces have different functions and limitations. As shown in Table 1, it compares functionalities of different file access protocols.

TABLE 1
Comparison of functionalities of different file access protocols.

| | Web File Access | CIFS | File Syncing |
|---|---|---|---|
| Support file access locking | No | Yes | No |
| Support offline access | No | No | Yes |
| Support file versioning | No | No | Yes |
| Support authentication | Yes | Yes | Yes |
| Requires additional software | No | No | Yes |

According to Table 1, the CIFS protocol supports file access locking, which provides protocol with concurrency control capability. However, it also do not allow multiple devices or other file access protocols to concurrent updating the same file stored in cloud storage server. To synchronizing files and folders between client device and cloud storage server by using file syncing protocol, a file synchronization application has to be installed on client device to communicate and synchronize with cloud storage server. Since through file syncing protocol, files and folders in cloud storage server are also synchronized and stored in storage of client device, the client device can access these files and folders when offline. Further, modern file syncing services such as the Dropbox are supporting file versioning function, which deals with the file updating request by creating a new file version according to the file updating request and keeping the original file as one of versions in the file versioning history. Obviously, different file access protocols have their own advantages and limitations, and also they are suitable for applying in different application contexts. From the usage perspective, to access the same file by different file access protocols has to store multiple copies of the file in different cloud storage servers which support different file access protocols respectively. It is an inefficient way of using files, and the management of multiple copies/file versions among different cloud storage servers is difficult. Therefore, to conveniently access files and folders in cloud is to have all′ files and folders in a cloud storage server, which supports all different file access protocols such as web file access, CIFS, and file syncing at the same time. However, the properties/limitations of different file access protocols especially the file-locking property make one cloud storage server to have different file access become difficult.

Accordingly, what is needed is a system, a method and a non-transitory computer readable storage medium for supporting network file accessing and versioning with multiple protocols in a cloud storage server to address the above issues.

### SUMMARY

An aspect of the present invention is to provide a method for supporting network file accessing and versioning with multiple protocols in a cloud storage server. The method comprises the steps outlined below. A file update request is sent from a remote device and received by the cloud storage server. A specific file corresponding to the file update request in the cloud storage server is retrieved from a present version data storage area. The retrieved specific file in the present version data storage area of the cloud storage server is duplicated such that one of the specific file and the new file becomes a first file to be updated in the present version data storage and the other one of the specific file and the new file becomes a second file to be moved to an old version data storage area of the cloud storage server. The duplicated second file in the old version data storage area is also renamed to a unique identification file name to identify the specific file from files of the old version data storage area. The file update request is handled by the cloud storage server to update the first file in the present version data storage area. A database record is added to describe the versioning relationship between the updated first file in the present version data storage area and the renamed duplicated second file in the old version data storage area.

Another aspect of the present invention is to provide a system for supporting network file accessing and versioning with multiple protocols in a cloud storage server. The system comprises a plurality of interface command receiving modules, a storage module and a file update request processing module. The interface command receiving modules receive a file update request from a remote device. The storage module comprises a present version data storage area and an old version data storage area. The file update request processing module retrieves a specific file corresponding to the file update request from the present version data storage area, calculates an unique identification file name, duplicates the specific file to generate a new file such that one of the specific file and the new file becomes a first file to be updated in the present version data storage and the other one of the specific file and the new file becomes a second file to be moved to the old version data storage area, naming the second file by using the unique identification file name and updates the first file in the present version data storage area according to the received file update request. The file update request processing module further adds a database record to describe the versioning relationship between the updated first file in the present version data storage area and the renamed duplicated second file in the old version data storage area.

Yet another aspect of the present invention is to provide a computer readable storage medium to store a computer program to execute a method for supporting network file accessing and versioning with multiple protocols in a cloud storage server. The method comprises the steps outlined below. A file update request is received from a remote device. A specific file corresponding to the file update request is retrieved from a present version data storage area. A unique identification file name is calculated. The specific file is duplicated to generate a new file such that one of the specific file and the new file becomes a first file to be updated in the present version data storage and the other one of the specific file and the new file becomes a second file to be moved to the old version data storage area. The second file is named by using the unique identification file name. The first file is updated according to the file update request in the present version data storage area. A database record is added to describe the versioning relationship between the updated first file in the present version data storage area and the renamed duplicated second file in the old version data storage area.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of cloud network structure in an embodiment of the present invention;

FIG. 2 is a block diagram of the system in an embodiment of the present disclosure;

FIG. 3 is a structure of a file system of the data in the present version data storage area and the old version data storage area in an embodiment of the present disclosure;

FIG. 4 is a database table for identifying relationship between the files in present data storage area and the versions of files in the old version data storage area in an embodiment of the present disclosure; and

FIG. 5 is a flow chart of a method for accessing a file in a cloud storage server in an embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

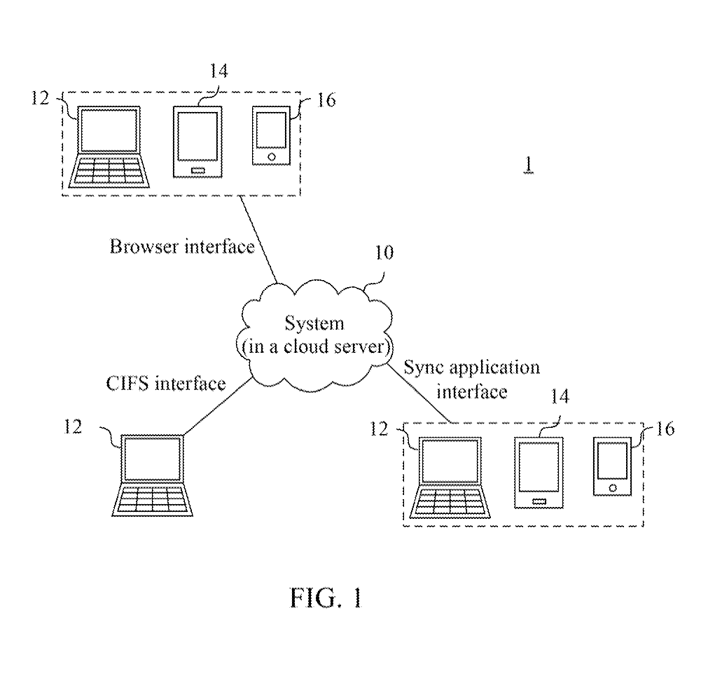

FIG. 1 is a block diagram of cloud network structure 1 in an embodiment of the present invention. The cloud network structure 1 comprises a system 10 for accessing a file in a cloud storage server and a plurality of remote devices that is able to access the system 10. In the present embodiment, the system 10 is a part of the cloud storage server, in which the remote devices can access the file in the system 10. The remote devices can be, but not limited to the computer host 12, the tablet 14 and the smart phone 16 depicted in FIG. 1.

The remote devices can access the file in the system 10 through various kinds of file access interface. For example, the devices equipped with a browser, e.g. the computer host 12, the tablet 14 and the smartphone 16, can log in to the system 10 through a web page to access the files therein. The devices equipped with a sync application, e.g. the computer host 12, the tablet 14 and the smart phone 16, can access the file through the installed sync application. Modifications made to the file on the devices can be reconciled with the corresponding file stored in the system 10 through data synchronization.

CIFS (common internet file system) interface is a network file sharing protocol that allows the machines within the same network (e.g. LAN) sharing the resources, such as the stored documents, the peripheral devices (e.g. printer) and the ports, to each other. CIFS interface is often implemented in the devices such as the computer host 12. However, when a file is editing by a user through the CIFS interface, it cannot be edited by other access requests at the same time. Further, modifications made to the file would replace the original content. The user cannot revert the file based on the comparison between the old version file and the present version file.

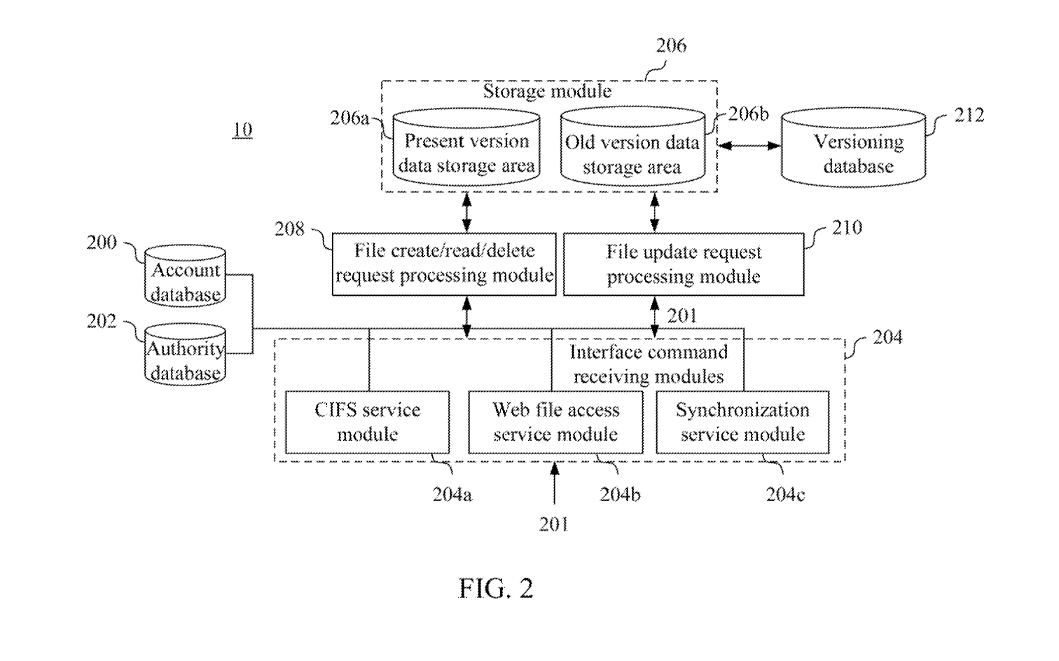

FIG. 2 is a block diagram of the system 10 in an embodiment of the present disclosure. The system 10 comprises an account database 200, an authority database 202, interface command receiving modules 204, a storage module 206 and a file create/read/delete request processing module 208, an update request processing module 210, and a versioning database 212.

An authentication process and an authorization process can be performed on a remote device that is accessing the system 10, in which the authentication and the authorization processes are performed base on the content in the account database 200 and the authority database 202. Through the authentication and the authorization processes, the system 10 can identify the user account corresponding to the remote device and the authority given to the user account for the files in the system.

The interface command receiving modules 204 receive a file update request 201 and other requests, including but not limited to a file create request, a file read request and a file delete request from the remote devices. In the present embodiment, the interface command receiving modules 204 includes three modules corresponding to the three file access protocols mentioned previously, namely the CIFS service module 204a, the web file access service module 204b and the file synchronization service module 204c. In other embodiments, the system 10 may comprises other kinds of file access service modules.

The storage module 206 comprises a present version data storage area 206a and an old version data storage area 206b. In the present embodiment, the present version data storage area 206a is a file storage area for storing present files of users and the old version data storage area 206b is a version storage area for storing versions of present files.

The file create/read/delete request processing module 208 processes the file create request, the file read request and the file delete request mentioned previously from the remote devices. The file create/read/delete request processing module 208 can create a new file in the storage module 206 and can read or delete the file in the storage module 206 according to the requests. The update request processing module 210 can modify or edit the file in the storage module 206 based on the file update request 201. In an embodiment, the update request processing module 210 actually modify or edit the file owned by a specific user in the storage module 206 based on both the file update request 201 and the authentication and authorization result from the account database 200 and the authority database 202.

The versioning database 212 stores the information of the versioning relationship between the file in a present version data storage area 206a in the storage module 206 and the file in an old version data storage area 206b in the storage module 206.

The detail of the file access process based on the file update request 201 performed by the update request processing module 210 is further discussed in the subsequent paragraphs.

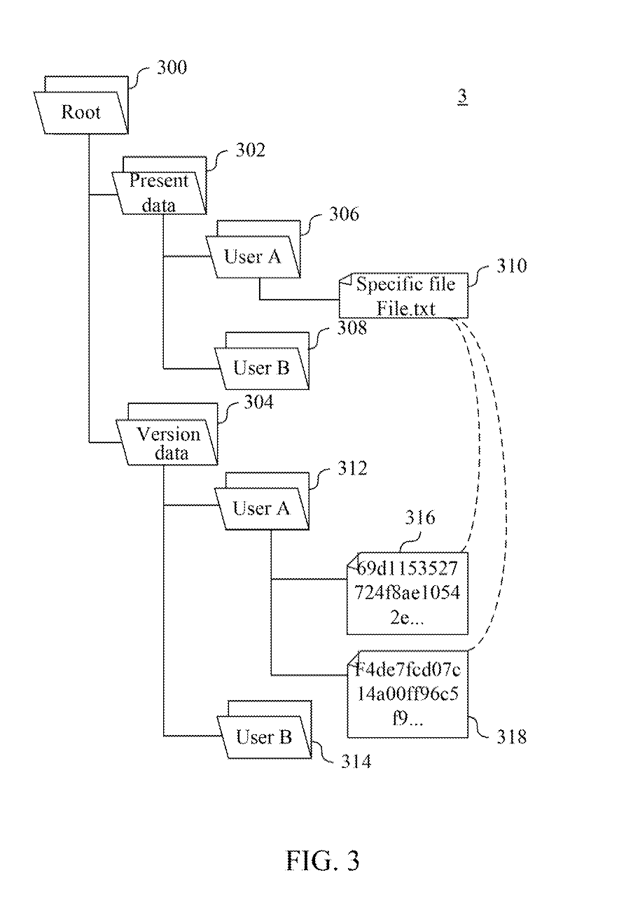

FIG. 3 is a hierarchical structure of a file system 3 of the files and folders in the present version data storage area 206a and the old version data storage area 206b in an embodiment of the present disclosure. In the root folder 300, a present data folder 302 corresponding to the present version data storage area 206a and a version data folder 304 corresponding to the old version data storage area 206b are located therein. In the present data folder 302, a user A folder 306 and a user B folder 308 corresponding to the present version data storages of a user A and a user B respectively are located therein. In the old version data folder 304, a user A folder 312 and a user B folder 314 corresponding to the old version data storages of user A and the user B respectively are located therein.

After the receiving of the file update request 201, the file update request processing module 210 retrieves a specific file corresponding to the file update request 201 from present data folder 302 corresponding to the present version data storage area 206a. In the present embodiment, the file update request processing module 210 retrieves the file having an original file name of 310 File.txt (specific file) depicted in FIG. 3 in the user A folder 306 based on the file update request 201 and the authentication and authorization processes.

The file update request processing module 210 calculates an identification file name and duplicates the specific file 310 to generate a new file. One of the specific file 310 and the new file becomes a first file to be updated in the present version data storage 206a and the other one of the specific file 310 and the new file becomes a second file to be moved to the old version data storage area 206b. In the present embodiment, the second file to be moved to the old version data storage area 206 (i.e. old version data storage 312 of user A) is the new file with the calculated unique identification name (a file 316 and another file 318 under folder 312 are two examples of the new file with unique identification names). Therefore, the first file to be updated is the original specific file 310.

In different embodiments, the identification file name is calculated based on different information. For example, the file name of a first old version file corresponding to the specific file can be calculated as a string of “69d1153527724f8ae10542e . . . ” and the file name of a second old version file corresponding to the specific file can be calculated as another string of “f4de7fcd07c14a00ff96c5f9 . . . ”. The calculation of the identification file name is to make each of the files in the old version data storage area 206b have a unique file name.

The file update request processing module 210 further updates the specific file 310 based on the content of the file update request 201.

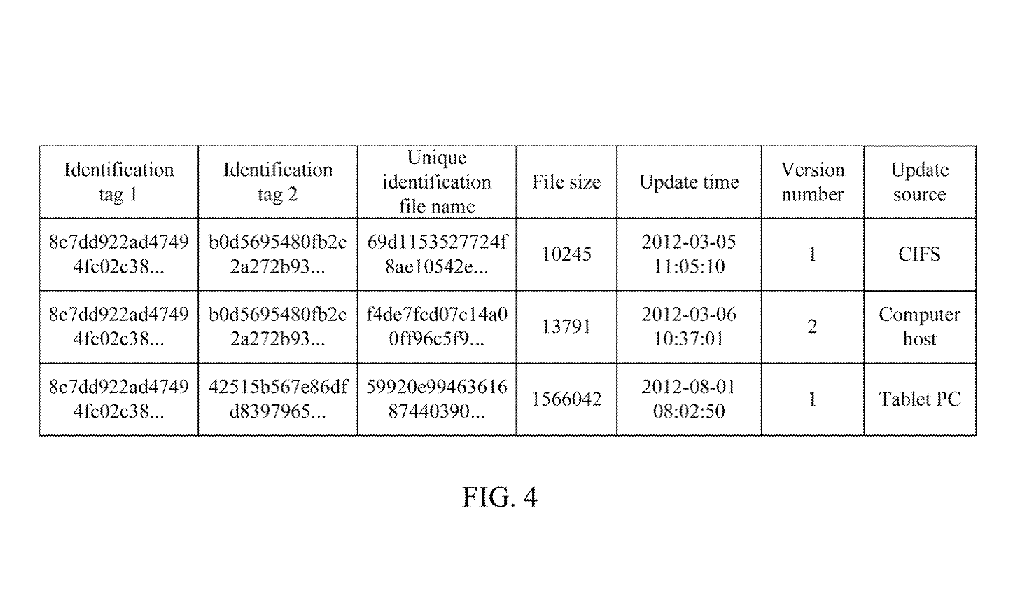

The file update request processing module 210 finally adds a new record into the versioning database 212. FIG. 4 is a database table for identifying relationship between the files in present data storage area 206a and the versions of files in the old version data storage 206b in an embodiment of the present disclosure. As shown in FIG. 4, the new added record composes of two identification tags (identification tag 1 and identification tag2) for identifying specific file 310, a unique identification file name for identifying old version files, a file size of a corresponding old version file, an update time for storing the creation time of a corresponding old version file, a version number for determining versioning number information from other versioning records in the versioning database 212, and an update source for identifying which remote device creates this version.

It is noted that the first two rows in the table of FIG. 4 correspond to two different versions of the same file. Though the last row has the same identification tag 1 with the first two rows, it corresponds to a file different from the file that the first two rows correspond to since it has a different identification tag 2. Note that using of more than one identification tag can efficiently avoid the collision condition when calculating the identification by hash function. The identification tag 1 of the third row is equal to the identification tag 1 of the first and second rows is because of collision.

It is noted that in an embodiment, the specific file 310 may be associated with at least two identification tags that are generated when the first version of the specific file 310 is created. Further, any updating to the specific file 310 will not change this association until the specific file 310 is deleted. In the present embodiment, the identification tags are generated by using different calculation methods, and the identification tags are stored in the extended file attribute of the special file 310. An identification tag may be a hash value generated according to a file path, a last update data, a file size or a combination of the above.

In FIG. 4, the files in the old version data storage 206b can be distinguished from each other by using the identification tags. The versions of the same file in the old version data storage 206b can be distinguished from each other by using the identification file name. The ambiguity among different files and versions can be avoided. Therefore, the desired version of file can be quickly accessed by the user even if there are many files with different number of versions in the old version data storage 206b.

In an embodiment, after the specific file 310 is duplicated to the user A folder 312, the file update request processing module 210 further determines whether a number of the old version files corresponding to the specific file 310 in the old version data storage area 206b exceeds a maximum file number. When the number exceeds the maximum file number, an oldest version file is removed from the user A folder 312. In another embodiment, the file update request processing module 210 determines whether a time duration that the old version files exists in the old version data storage 206b exceeds a predetermined time duration threshold. The old version files are removed when their time duration of existing in the old version data storage 206b exceeds the predetermined time duration threshold.

Consequently, the system of the present disclosure can duplicate the specific file 310 to the old version data storage as a version of the specific file 310. The old versions of the specific file 310 can be maintained and the specific file 310 can be edited by different file access protocols at the same time without being locked by particular types of protocols. Additionally, the file access protocols that originally do not support file-versioning are able to support file versioning function in the invention.

It is noted that in the above embodiment, the first file to be updated is the specific file 310 and the second file to be moved to the old version data storage area is the duplicated new file. In other embodiments, the first file to be updated can be the duplicated new file and the second file to be moved to the old version data storage area can be the original specific file.

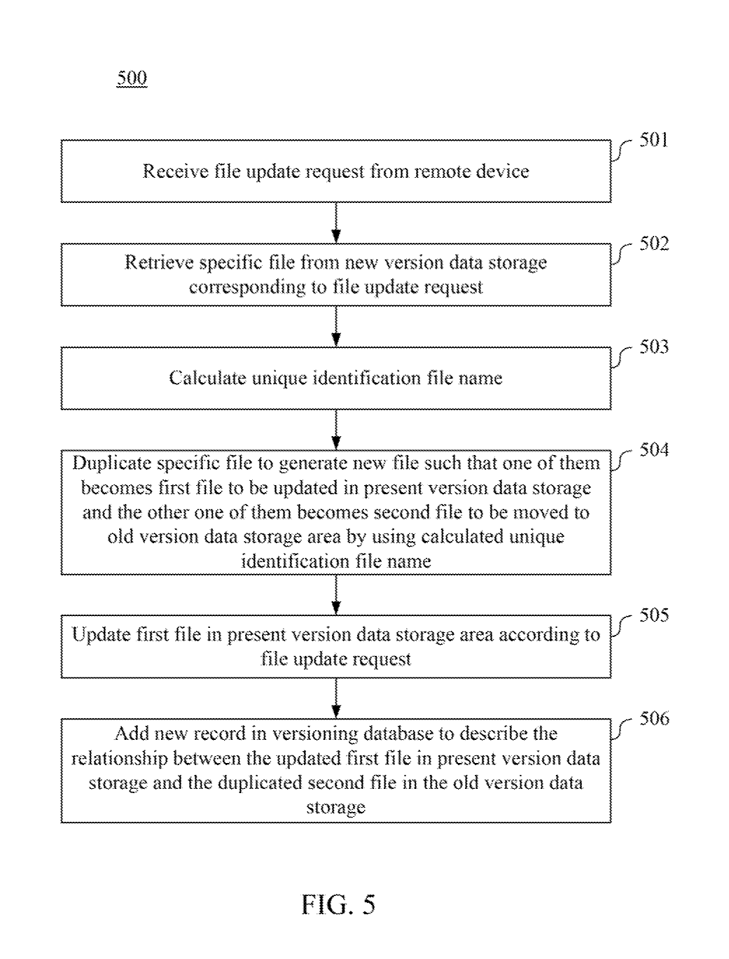

FIG. 5 is a flow chart of a method 500 for accessing a file in a cloud storage server in an embodiment of the present disclosure. The method 500 can be used in the system 10 depicted in FIG. 2. The computer program can be stored in a non-transitory computer readable medium such as a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

The method 500 comprises the steps as outlined below.

In step 501, the interface command receiving modules 204 receive the file update request 201 from the remote device.

In step 502, the update request processing module 210 retrieves a specific file (File.txt) from the present version data storage 206a corresponding to the file update request 201.

In step 503, the update request processing module 210 calculates an unique identification file name.

In step 504, the update request processing module 210 duplicates the specific file from the present version data storage area 206a such that one of the specific file and the new file becomes a first file to be updated in the present version data storage 206a and the other one of the specific file and the new file becomes a second file to be moved to the old version data storage area 206b, and names the new duplicated file by using the unique identification file name generated in step 503.

In step 505, the update request processing module 210 edits the first file according to the file update request 201.

In step 506, the update request processing module 210 adds a new record in the versioning database 212 to describe the relationship between the updated first file in present version data storage area 206a and the duplicated second file in the old version data storage area 206b.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for supporting network file accessing and versioning with multiple protocols in a cloud storage server, wherein the method comprises:
receiving a file update request from a remote device;
retrieving a specific file corresponding to the file update request from a present version data storage area;
calculating a unique identification file name;
duplicating the specific file to generate a new file such that one of the specific file and the new file becomes a first file to be updated in the present version data storage and the other one of the specific file and the new file becomes a second file to be moved to an old version data storage area;
naming the second file by using the unique identification file name;
updating the first file in the present version data storage area according to the file update request; and
adding a database record to describe a versioning relationship between the updated first file in the present version data storage area and the second file in the old version data storage area.

2. The method of claim 1, wherein the specific file further comprises two identification tags that are generated when an original file of the specific file is created, and the step of duplicating the specific file further comprises copying the two identification tags to the new file.

3. The method of claim 2, wherein the two identification tags are generated according to an extended file attribute of the original file respectively.

4. The method of claim 3, wherein the extended file attribute is a hash value generated according to a file path, a last update data, a file size or a combination of the above.

5. The method of claim 1, wherein the file update request is received through a common Internet file system (CIFS) service module, a web file access service module or a synchronization service module.

6. The method of claim 1, further comprising a step of determining whether a number of at least one old version file exceeds a maximum file number such that an oldest version file is removed when the number of the old version file exceeds the maximum file number, wherein the old version file is stored in the old version data storage area and is corresponding to the specific file.

7. The method of claim 1, further comprising a step of determining whether a time duration that at least one old version file exists in the old version data storage exceeds a predetermined time duration threshold such that the old version file is removed when the time duration that the old version file exists in the old version data storage exceeds the predetermined time duration threshold, wherein the old version file is corresponding to the specific file.

8. A system for supporting network file accessing and versioning with multiple protocols in a cloud storage server, wherein the system comprises:
a plurality of interface command receiving modules for receiving a file update request from a remote device;
a storage module comprising a present version data storage area and an old version data storage area; and
a file update request processing module for retrieving a specific file corresponding to the file update request from the present version data storage area, calculating a unique identification file name, duplicating the specific file to generate a new file such that one of the specific file and the new file becomes a first file to be updated in the present version data storage and the other one of the specific file and the new file becomes a second file to be moved to an old version data storage area, naming the second file by using the unique identification file name, updating the first file in the present version data storage area according to the file update request and adding a database record to describe a versioning relationship between the updated first file in the present version data storage area and the second file in the old version data storage area.

9. The system of claim 8, further comprising an account database and an authority database for performing an authentication process and an authorization process on the remote device, wherein the file update request processing module accesses the storage module according to the file update request and a result of the authentication process and the authorization process.

10. The system of claim 8, wherein the specific file further comprises two identification tags that are generated when an original file of the specific file is created, and the file update request processing module further copies the two identification tags to the new file.

11. The system of claim 10, wherein the two identification tags are generated according to an extended file attribute of the original file respectively.

12. The system of claim 11, wherein the extended file attribute is a hash value generated according to a file path, a last update data, a file size or a combination of the above.

13. The system of claim 8, wherein the plurality of interface command receiving modules comprise a common Internet file system (CIFS) service module, a web file access service module or a synchronization service module.

14. The system of claim 8, wherein file update request processing module further determines whether a number of at least one old version file exceeds a maximum file number such that an oldest version file is removed when the number of the old version file exceeds the maximum file number, wherein the old version file is stored in the old version data storage area and is corresponding to the specific file.

15. The system of claim 8, wherein file update request processing module further determines whether a time duration that at least one old version file exists in the old version data storage exceeds a predetermined time duration threshold such that the old version file is removed when the time duration that the old version file exists in the old version data storage exceeds the predetermined time duration threshold, wherein the old version file is corresponding to the specific file.

16. The system of claim 8, further comprising a versioning database, wherein the database record is added to the versioning database.

17. A non-transitory computer readable storage medium to store a computer program to execute a method for supporting network file accessing and versioning with multiple protocols in a cloud storage server, wherein the method comprises:
receiving a file update request from a remote device;
retrieving a specific file corresponding to the file update request from a present version data storage area;
calculating a unique identification file name;
duplicating the specific file to generate a new file such that one of the specific file and the new file becomes a first file to be updated in the present version data storage and the other one of the specific file and the new file becomes a second file to be moved to an old version data storage area;
naming the second file by using the unique identification file name;
updating the first file in the present version data storage area according to the file update request; and
adding a database record to describe a versioning relationship between the updated first file in the present version data storage area and the second file in the old version data storage area.

18. The non-transitory computer readable storage medium of claim 17, wherein the specific file further comprises two identification tags that are generated when an original file of the specific file is created, and the step of duplicating the specific file further comprises copying the two identification tags to the new file.

19. The non-transitory computer readable storage medium of claim 18, wherein the two identification tags are generated according to an extended file attribute of the original file respectively.

20. The non-transitory computer readable storage medium of claim 19, wherein the extended file attribute is a hash value generated according to a file path, a last update data, a file size or a combination of the above.

21. The non-transitory computer readable storage medium of claim 17, wherein the file update request is received through a common Internet file system (CIFS) service module, a web file access service module or a synchronization service module.

22. The non-transitory computer readable storage medium of claim 17, wherein the method further comprises a step of determining whether a number of at least one old version file exceeds a maximum file number such that an oldest version file is removed when the number of the old version file exceeds the maximum file number, wherein the old version file is stored in the old version data storage area and is corresponding to the specific file.

23. The non-transitory computer readable storage medium of claim 17, wherein the method further comprises a step of determining whether a time duration that at least one old version file exists in the old version data storage exceeds a predetermined time duration threshold such that an oldest version file is removed when the time duration that the old version file exists in the old version data storage exceeds the predetermined time duration threshold, wherein the old version file is corresponding to the specific file.
